(19) United States
(12) Patent Application Publication
(10) Pub. No.: US 2024/0157598 A1
(43) Pub. Date: May 16, 2024

(54) ADDITIVE MANUFACTURING HOT-ISOSTATIC PRESS PROCESS FOR MANUFACTURING A PART

(71) Applicant: Grid Logic Incorporated, Lapeer, MI (US)

(72) Inventors: Matthew James Holcomb, Metamora, MI (US); Ira James Holcomb, Jr., Oxford, MI (US)

(73) Assignee: Grid Logic Incorporated, Lapeer, MI (US)

(21) Appl. No.: 18/495,296

(22) Filed: Oct. 26, 2023

Related U.S. Application Data
(60) Provisional application No. 63/542,423, filed on Oct. 4, 2023.
(60) Provisional application No. 63/420,257, filed on Oct. 28, 2022.

(51) Int. Cl. B28B 1/00; B28B 11/04; B28B 11/24; B33Y 10/00; B33Y 40/20; B33Y 50/00; B33Y 70/00

(52) U.S. Cl. CPC B28B 1/001; B28B 11/04; B28B 11/243; B33Y 10/00; B33Y 40/20; B33Y 50/00; B33Y 70/00

(57) ABSTRACT

Successive layers are printed, wherein each layer comprises at least a layer of the part and wherein the layer of the part is surrounded by a piece of a hot-isostatic press (HIP) can. The HIP can forms a sealed container with the part inside the HIP can is processed in a HIP.

### CROSS-REFERENCE TO RELATED APPLICATIONS

This application claims priority from U.S. Provisional Patent Application No. 63/542,423, filed on Oct. 4, 2023, and U.S. Provisional Patent Application No. 63/420,257, filed on Oct. 28, 2022, each of which is incorporated herein by reference in their entirety.

### STATEMENT REGARDING FEDERALLY SPONSORED RESEARCH OR DEVELOPMENT

Certain aspects of this invention were developed with support from the U.S. Department of Energy (DOE). The U.S. Government may have rights in certain of these inventions.

### BACKGROUND OF THE INVENTION

### 1). Field of the Invention

This invention relates to a method of forming a part and to a manufacture for forming a part.

### 2). Discussion of Related Art

In recent years, the nuclear power industry has been exploring the use of conventional powder metallurgy (PM) and hot-isostatic press (HIP) technologies to fabricate large, near net shape components for high pressure components and other applications pertaining to the generation of electric power. Powder metallurgy has many advantages over other large-scale manufacturing methods (e.g. casting, welding, forging etc.), which include the fabrication of near-net shape (NNS) parts with controlled chemistry and improved microstructure in the part.

As shown in FIGS. 1A and 1B, large-scale parts are manufactured in a PM-HIP process by first fabricating a conformal HIP can 40, or mold, in a size slightly larger than shape of the part 42. The HIP can 40 is typically fabricated by welding thin, mild steel sheets to the approximate shape of the part 42 and rigging the mold with a series of ports through which the metal powder can be introduced. The HIP can 40 is then uniformly filled with metal powder and evacuated and sealed. After leak checking the HIP can 40 to confirm the quality of the welds, the HIP can 40 is placed in the HIP for processing, which involves the application of both heat and pressure. During this process, the HIP can 40 compresses the metal powder, which sinters and consolidates the metal powder to full density. Typical HIP processing parameters range from 500° C. to 1200° C. at pressures from 7 ksi to 45 ksi. After the HIP process, the HIP can 40 is removed by machining or acid etching the mild steel off of the consolidated NNS part 42.

In general, the design and fabrication of the HIP can 40 is critical to the successful fabrication of the part 42 using PM-HIP technology. HIP can fabrication is both an engineering and labor intensive process that involves the design and fabrication of a conformal mold that collapses under high pressure and temperature. In addition, the geometry of the part 42 fabricated in this process is limited by the geometry of the HIP can 40 and the ability to uniformly fill the mold with metal powder, which is critical to the quality of the part 42.

In order to overcome the current technology limitations of part fabrication using PM-HIP technologies, enable the unit cost reduction associated with the fabrication of a geometrically complex HIP can, and improve the uniform fill density of the metal powder within the HIP can 40, a new approach is needed. Ideally, this approach will possess the following characteristics:
(A) Eliminate the need for a conformal, welded HIP can 40 in the fabrication process of the part 42. As seen FIG. 1A, even a relatively simple HIP can 40 can be fabricated by welding a large number of individual pieces 44 of mild steel together. In addition to the engineering cost associated with the design of the HIP can 40, there is considerable labor cost with both the fabrication of components and final assembly of the HIP can 40. The more geometrically complex the part 42, the higher the labor and materials costs associated with the fabrication of the HIP can 40.
(B) Provide qualification data on the uniformity of the metal powder pack density in the HIP can 40. The uniform filling of the HIP can 40 with metal powder is critical to the quality of the part 42. Metal powders used in PM have a broad particle size distribution (PSD) in order to increase the bulk density of the powder in the HIP can 40. During the filling process, mechanical vibration is used to increase the pack density, but this vibration can also lead to size segregation in the powder pack. In addition, there may be variations in powder pack density in a geometrically complex HIP can 40, which can have an impact on the quality of the final part. An in-process measurement of the local pack density in the part 42 would allow for a means to qualify the powder packing before the HIP process and reduce part-to-part variation.

### SUMMARY OF THE INVENTION

We describe an additive manufacturing (AM) process to fabricate geometrically complex parts using a multi-material 3-dimensional (3D) printing technology coupled with conventional PM-HIP processing. In addition, this technology allows for the real-time measurement of the individual powder masses throughout the 3D printing process that gives a direct measure of the pack density of the part in the HIP can. In the following, we describe two different approaches to part fabrication:

Part fabrication using 3D printed HIP cans multi-material 3D printing technology allows for the 3D printing of both the part and the HIP can within the same build cartridge. Post-print heat treatment of the 3D powdered structure results in the fabrication of a fully dense 3D printed HIP can around an un-sintered powder structure, which is then processed in a conventional HIP cycle. This approach eliminates the need to fabricate a conformal, welded HIP can, but is limited to the size of the furnace used to heat treat the build cartridge.

Part fabrication can be carried out using non-conformal welded HIP cans. Multi-material 3D printing technology allows for the 3D printing of the part and supporting powders in a non-conformal welded HIP can. After printing is complete, the can is degassed and sealed for HIP processing. During the HIP process, the metal powder sinters and consolidates under pressure transferred through the supporting powder. The supporting powder may remain loose during the HIP process or can be selected to sinter along with the metal powder with the requirement that it is easily separated from the part after HIP processing. This approach eliminates the need to fabricate a conformal HIP can and is only limited to the size of the multi-material 3D printer and the dimensions of the HIP.

These manufacturing processes not only allow for the fabrication of complex parts and the in-process monitoring of the 3D powder pack density, but have the potential to reduce the unit cost of PM-HIP parts through the elimination of the conformal welded HIP can fabrication in the PM-HIP manufacturing process.

The invention provides a method of forming a part that includes printing successive layers, wherein each layer comprises at least a layer of the part and wherein the layer of the part is surrounded by a piece of a hot-isostatic press HIP can.

The invention also provides a method of forming a part that includes locating a HIP can forming a sealed container with a part inside the HIP can in a HIP, the part including successively printed layers, wherein each layer comprises at least a layer of the part and wherein the layer of the part is surrounded by a piece of a HIP can, increasing a temperature within the HIP can and a pressure on the outside of the HIP can using the HIP to deform the HIP can, removing the HIP can with the part inside the HIP can from the HIP, and removing the part from the HIP can.

The invention further provides a manufacture that includes a HIP can forming a sealed container, and a part inside the HIP can, the part including successively printed layers, wherein each layer comprises at least a layer of the part and wherein the layer of the part is surrounded by a piece of a HIP can, wherein the HIP can is insertable in a HIP to increase a pressure on the outside of the HIP can to deform the HIP can.

### BRIEF DESCRIPTION OF THE DRAWINGS

The invention is further described by way of example with reference to the accompanying drawings, wherein:

FIG. 1A is a perspective view of a welded HIP can;

FIG. 1B) is a perspective view of a part;

FIGS. 2A to 2C are a 3D computer-aided design (CAD) model in perspective view;

FIGS. 3A to 3C each show a respective layer of the CAD model and a perspective view of a layer that is printed in a 3D build;

FIG. 4A is a perspective view of a part that is being removed from a supporting powder;

FIG. 4B is a perspective view of the part in FIG. 4A;

FIG. 5A is a perspective view of a 3D printer;

FIG. 5B is a graph of multi-material print mass vs time.

FIG. 5C is a close-up photo of a multi-material print layer;

FIGS. 6A to 6J show the fabrication of complex parts;

FIGS. 7.1A to 7.1F show the fabrication of parts using multi-material 3D printing of powders into a non-conformal welded HIP can;

FIGS. 7.2A to 7.2E show the fabrication of parts using a multi-material 3D printing of powders to form both the part and the HIP can in the same build cartridge;

FIGS. 8A, 8B, 9 and 10 are perspective views that show a large-scale AM-HIP manufacturing system;

FIGS. 11A to 11H illustrate refractory part fabrication by 3D printing a refractory metal HIP can around a part;

FIG. 12 is a top plan view showing alternative cross-sections of HIP cans and the part that result therefrom;

FIGS. 13A to 13H show a UHTC manufacturing process;

FIGS. 14A and 14B are cross-sectional side views of a 3D printed powder part in a supporting powder;

FIG. 15A to 15E illustrates perspective views of the same cylindrical tube fabricated using different shaped HIP cans and placements in a HIP can;

FIGS. 16A and 16B each show the pre-HIP CAD model and the expected distortion of the part after a HIP cycle due to non-isotropic pressure within the HIP can;

FIGS. 17A to 17E are various views of more difficult to manufacture geometrically complex parts;

FIGS. 18A and 18B are cross-sectional side views of a build that allows for a more isotropic pressure distribution;

FIG. 19 is a perspective view of a part that is removed from a HIP can after being fabricated using the process in FIGS. 18A and 18B;

FIG. 20 is a graph that shows the viscosity of some glasses as a function of temperature;

FIGS. 21A and 21B are cross-sectional side views of a build wherein the supporting powder includes a small amount of melted salt;

FIGS. 22A and 22B are perspective and cross-sectional side views that show a simple cylindrical glass surround around a powder part tube;

FIGS. 23A and 23B are perspective and cross-sectional side views that show the same powder part tube in FIGS. 22A and 22B with glass material that is also located within the center of the tube;

FIGS. 24A and 24B are perspective views that show the fabrication of extremely complex structures;

FIG. 25 shows a typical HIP process cycle;

FIG. 26 shows a typical HIP process schedule for NNS part fabrication using a glass component surrounding the part;

FIGS. 27A to 27E show the fabrication of a tubed sphere part by fusing glass in an open HIP can; and

FIGS. 28A to 28E are perspective views of geometrically complex parts that have been fabricated.

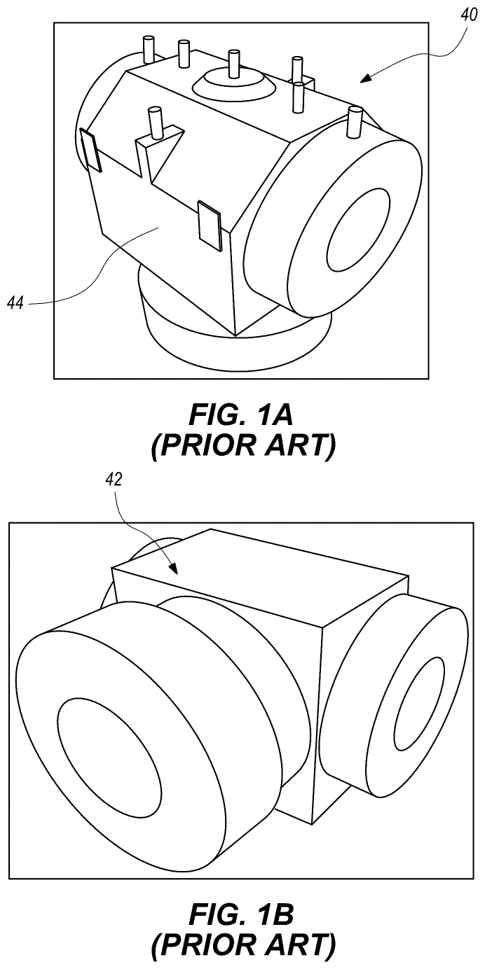

### DETAILED DESCRIPTION OF THE INVENTION

Our multi-material 3D powder printing technology permits the rapid structured deposition of multiple materials on a layer-by-layer basis to form a 3-dimensional powdered structure within a build cartridge. A fundamental aspect of this technology is the use of “positive,” “negative,” and “auxiliary” powders. By convention, positive and auxiliary powders form the consolidated part after processing (e.g., controlled atmosphere furnace, HIP, etc.), while negative powders confine the other powders to a specific shape in each layer. Negative powders therefore serve as an additively fabricated supporting structure in the powder bed, which remains loose or is easily removed after the processing of the build cartridge. In the following example, a multi-material positive/auxiliary powder part is printed in a negative supporting powder. The part, in this example, is a copper rotor with soft magnetic composite poles that is supported by zircon casting sand.

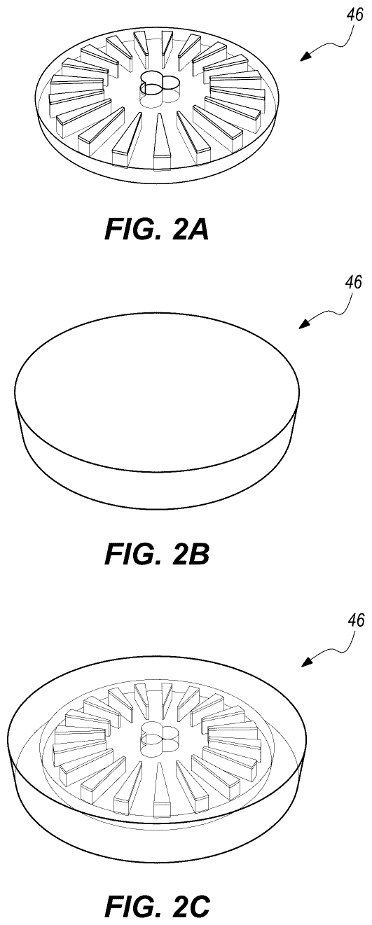

As illustrated in FIGS. 2A, 2B and 2C, the selective powder deposition process begins with a multi-material CAD model 46 of the part and all other powders used to either fabricate or support the part during the additive manufacturing process. FIG. 2A shows the CAD model 46 of the rotor that is printed with the positive and auxiliary powders. FIG. 2B shows the exterior view of the supporting negative powder. The complete 3D powder structure consists of negative, positive, and auxiliary powders with 100% of the CAD model 46 volume filled. FIG. 2C shows the location of the multi-material rotor inside the negative support block. During the 3D printing process, all materials are deposited layer-by-layer within a build cartridge that is slightly larger than the negative supporting material shown in FIG. 2B.

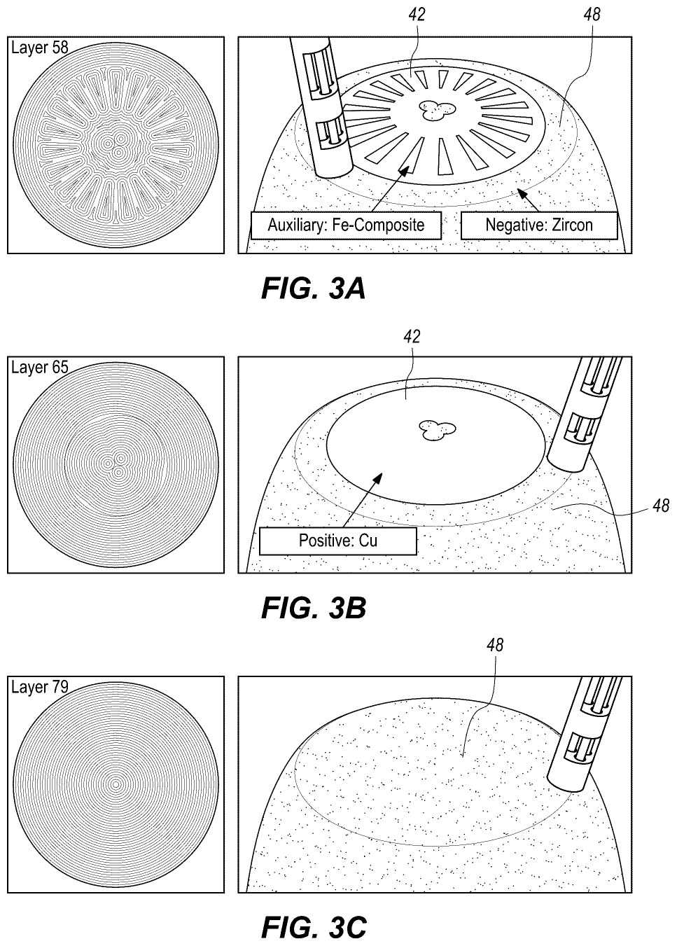

After slicing the CAD model 46, instructions are generated and monitored during the AM process using a multi-material 3D printing system control program. As shown in FIGS. 3A to 3C, the powder deposition process is repeated on a layer-by-layer basis to form a 3D multi-material powder part 42 that is surrounded with a 3D powder support structure. FIG. 3A shows Layer 58 of the build, which is the one of the topmost layers of the rotor assembly, together with a portion of negative zircon that forms supporting powder 48. FIG. 3B shows Layer 65 of the build, which shows the top layer of copper that encapsulates the rotor poles of the part 42. FIG. 3C shows layer 79 of the build, which is the top negative supporting powder 48 that covers the 3D powdered rotor structure. This print is comprised of 90 layers and took approximately 18 hours to complete with 0.5 mm thick layers. The 3D powdered structure in the build cartridge retains its shape during the printing process without the use of any binder and is fully supported by the negative casting sand in the build cartridge.

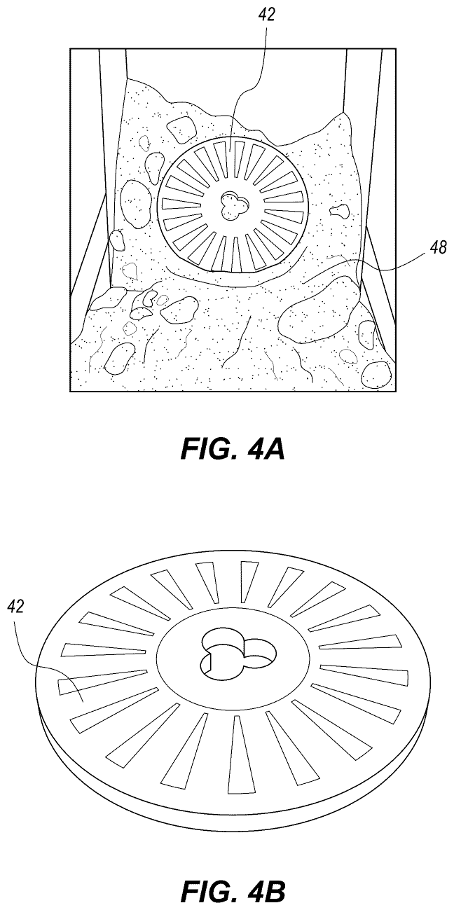

After the 3D powder printing process, the rotor is consolidated using a sintering heat treatment under controlled atmosphere. During the first portion of the heat treatment cycle, the entire build cartridge is heated at a controlled rate to the sintering temperature. After soaking at the sintering temperature, the build cartridge is cooled slowly to room temperature. Upon cooling, the multi-material part 42 is easily removed from the loose zircon sand. FIG. 4A shows the rotor in the build cartridge after heat treatment. The entire assembly is easily removed from the zircon powder, which does not sinter during the entire heat treatment schedule. FIG. 4B shows the same part 42 after machining the top layers of copper from the surface of the rotor to expose the soft magnetic composite poles.

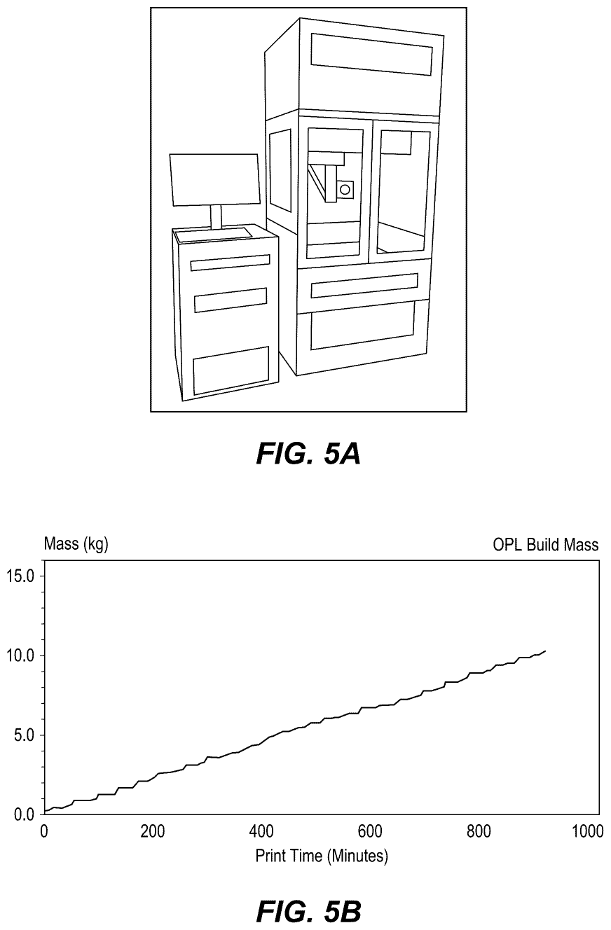

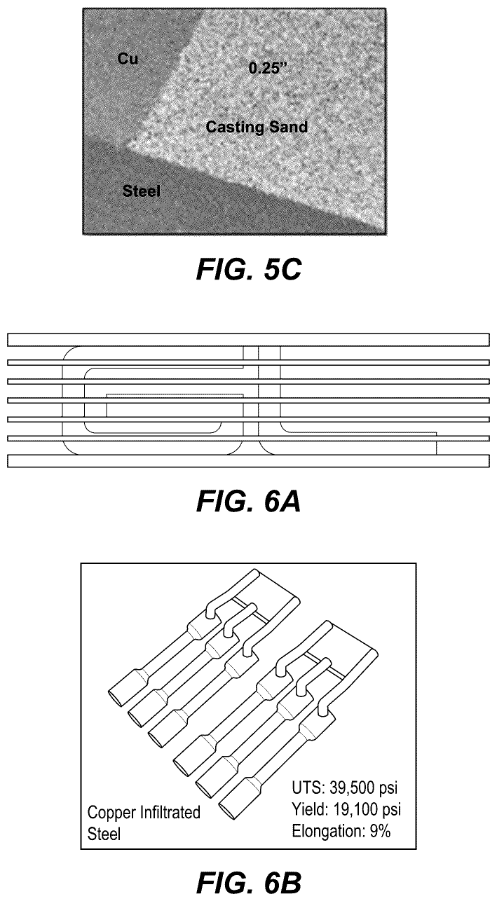

Unlike other AM systems, our multi-material printers can print many types of powders during the deposition process, including most low-cost powder metallurgy feedstock, casting sands, ceramics, and many other powders so long as there are no flow restrictions through the printhead. In addition, the mass of the build cartridge is measured in real-time during the printing process and correlated to the specific powder that is being printed. This allows for the in-process qualification of the print and the direct measurement of any part-to-part variation in the AM process. In general, the positive part powder mass varies less than 1% for identical multi-material print toolpaths. The printer named “GL-250 multi-material 3D printer” used by Grid Logic, Inc. of Lapeer, Michigan is shown in FIG. 5A. This commercial multi-material additive manufacturing system is capable of printing three distinct powders in an ordered fashion. Printer-specific instructions are generated automatically from input CAD data with little to no operator input. The powder deposition process can take place in build cartridges or upon any sufficiently stable surface. FIG. 5B shows an example multi-material print mass vs time graph demonstrating the in-process qualification measurement of the technology. FIG. 5C is a close-up photo of a multi-material print layer that illustrates the high quality of the powder deposition that can be achieved using this technology.

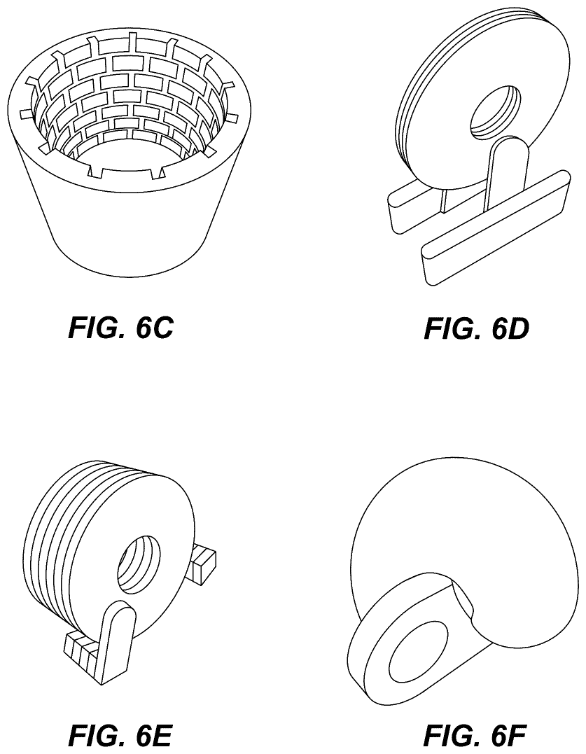

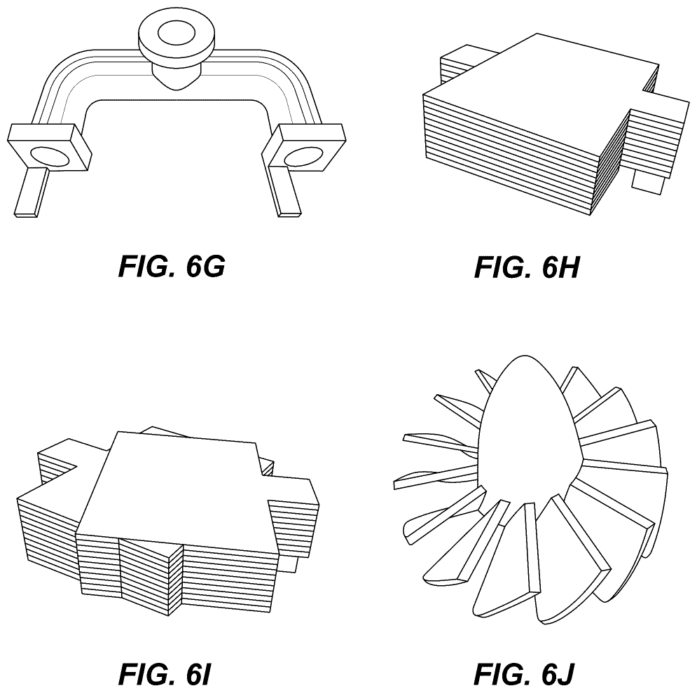

FIGS. 6A to 6J show a selection of metal parts fabricated using our multi-material 3D printing technology. To date, high-speed multi-material 3D printers have powder deposition rates in excess of 20 cm³/minute, which corresponds to a build rate of about 9.4 kg/hour for parts made from commercial steel powders. In addition, our multi-material 3D printers have a maximum external feature resolution of approximately 100 μm with a minimum feature size of approximately 0.5 mm.

Multi-material printing of powders allows for the fabrication of parts with varying densities in the build. The particle size distribution and particle morphology determine the as-printed density of powders. Unimodal spherical particles, for example, will have a higher print density than irregular shaped particles of the same material. For example, the as-printed density of spherical Cu powder with a diameter of 50 to 100 microns is about 60%. In contrast, the as-printed density of irregular Cu powder with an average particle size of about 150 microns is about 40%. This technology allows for the fabrication of parts with varying densities of materials, assuming that the material is not sintered to full density, which can be achieved through proper processing times and temperatures. Cu, for example, can be fully sintered to near 100% dense at 1074° C., but processing at 900° C. results in a partially sintered material that is approximately 70% dense.

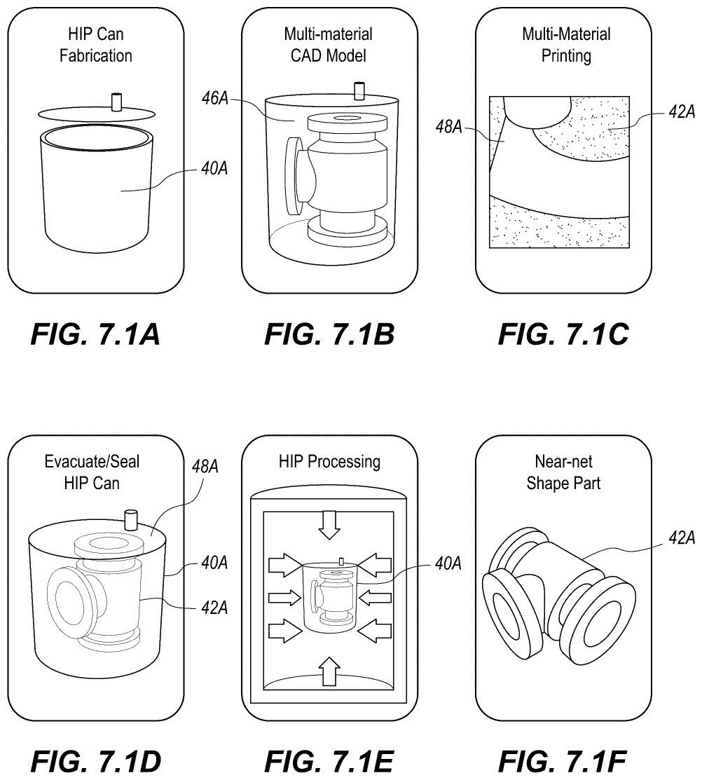

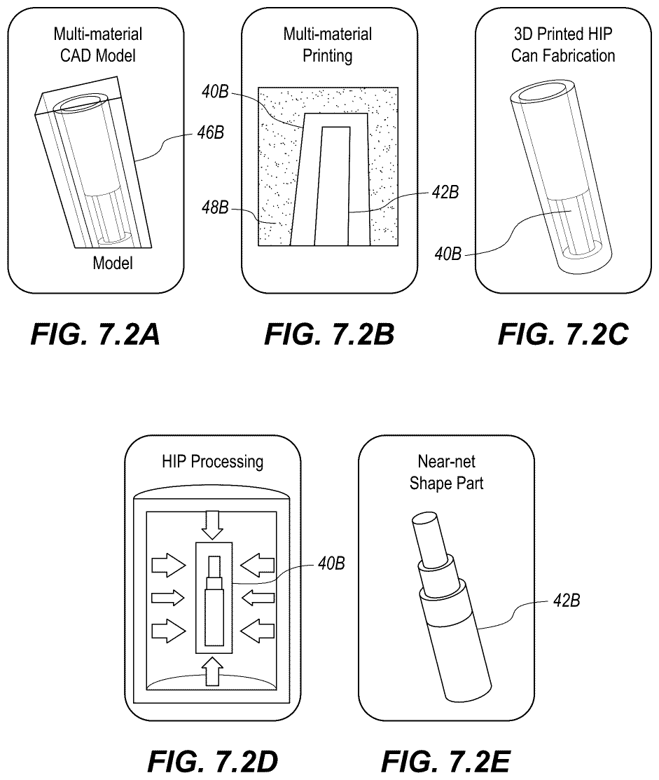

Two examples of advanced multi-material additive manufacturing processes are shown schematically in FIGS. 7.1A to 7.1F and 7.2A to 7.2E.

FIGS. 7.1A to 7.1F show the fabrication of parts using multi-material 3D printing of powders into a non-conformal welded HIP can 40A. The end-to-end process consists of six general steps as described below.

FIG. 7.1A: HIP can Fabrication. Non-conformal welded HIP cans are fabricated using mild steel sheet as is used in conventional PM-HIP processing. It is anticipated that these cans are cylindrical or rectangular in shape.

FIG. 7.1B: Multi-material computer-aided design (CAD). A two-powder CAD model 46A is developed and are designed using metal powder for a part 42A and a supporting powder 48A. A supporting powder 48A is used to maintain the shape of the metal powder during 3D printing and to transfer pressure to the part 42A during the HIP process.

FIG. 7.1C: Multi-Material Printing. Successive layers are multi-material layers that are printed inside the HIP can 40A based on the CAD model in the HIP can 40A after the HIP can 40A has been fabricated. Samples can be printed using our suite of multi-material printers with build volume dimensions ranging from 250 mm to 1000 mm. Our powder printers allow for the deposition of 3D structures in the powder bed without the use of a carbon-containing binder. These binders are commonly used in PM and must be carefully removed during a de-binding heat treatment. Multi-material printing of 3D structures directly in a HIP can 40A without the use of binders obviates this problem.

FIG. 7.1D: Evacuate/Seal HIP Can. After the multi-material print, each non-conformal HIP can 40A is degassed and sealed via tungsten inert gas (TIG) welding. All sealed cans are helium leak checked.

FIG. 7.1E: HIP Processing. During this step, the HIP can 40A and the part 42A are inserted in a HIP and the HIP is used to create external pressure on the HIP can 40A. The HIP can 40 deforms. Depending on geometries, the part 42A may also deform.

FIG. 7.1F: Near-net Shape Part. NNS parts are recovered from the non-conformal welded HIP cans after processing. This includes the removal of the HIP can 40A and retrieving of the part 42A from the supporting powder 48A. Mechanical and dimensional characteristics are measured in-house.

FIGS. 7.2A to 7.2E show the fabrication of parts using a multi-material 3D printing of powders to form both a part 42B and the HIP can 40B in the same build cartridge. The end-to-end process consists of five general steps.

FIG. 7.2A: Multi-material CAD model Design. A multi-material CAD model 46B is designed using a minimum of two metal powders and a supporting powder 48B. The metal powders are used to print both the part 42B and a HIP can 40B that envelopes the part 42B. The supporting powder 48B is used to maintain the shape of the metal powder part and the HIP can 40B during 3D printing and to transfer pressure to the metal powder part during the HIP process. The 3D printed HIP cans may or may not conform to the shape of the part 42B in this manufacturing approach.

FIG. 7.2B: Multi-Material Printing. Successive layers are multi-material layers that are printed based on the CAD model 46B and each one of the successive layers that are printed includes the respective piece of the HIP can 40B. Samples can be printed using our suite of multi-material printers with build volume dimensions ranging from 250 mm to 1000 mm. All samples are printed with three or four different materials in the build cartridge. Each layer includes a first supporting powder for the positive and auxiliary powder for the part 42B and a second supporting powder for the powder for the HIP can 40B.

FIG. 7.2C: 3D Printed HIP can Fabrication. After the multi-material 3D print, the build cartridge is processed in an inert atmosphere at a temperature that results in the formation of a dense HIP can 40B surrounding the unconsolidated powder for the eventual part 42B. This high temperature process is designed to consolidate the HIP can 40B through sintering and/or metal infiltration, but not necessarily sinter the part 42B within the HIP can 40B. After heat treatment, the 3D printed HIP cans are helium leak checked before shipping to the HIP processing facility.

The process shown in FIG. 7.2D (HIP Processing) and FIG. 7.2E (the NNS part) are identical to the last two processing steps shown in FIGS. 7.1D and 7.1E.

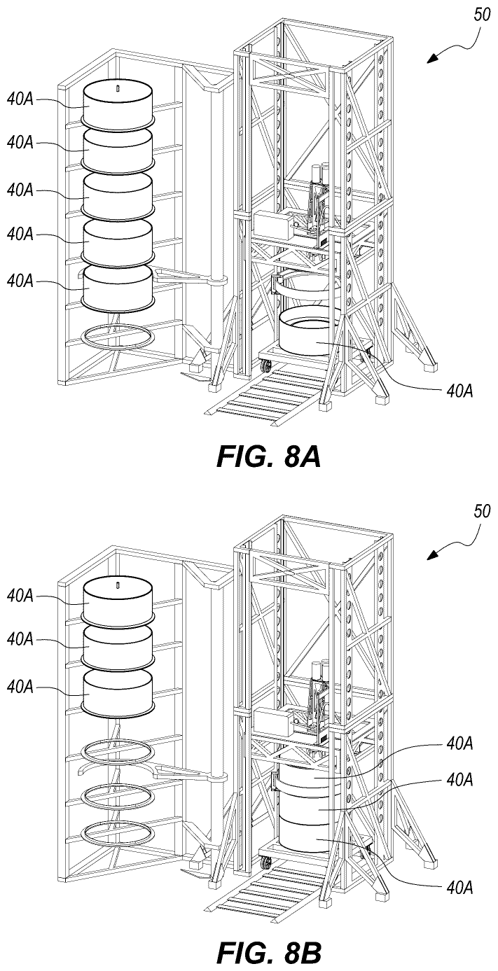

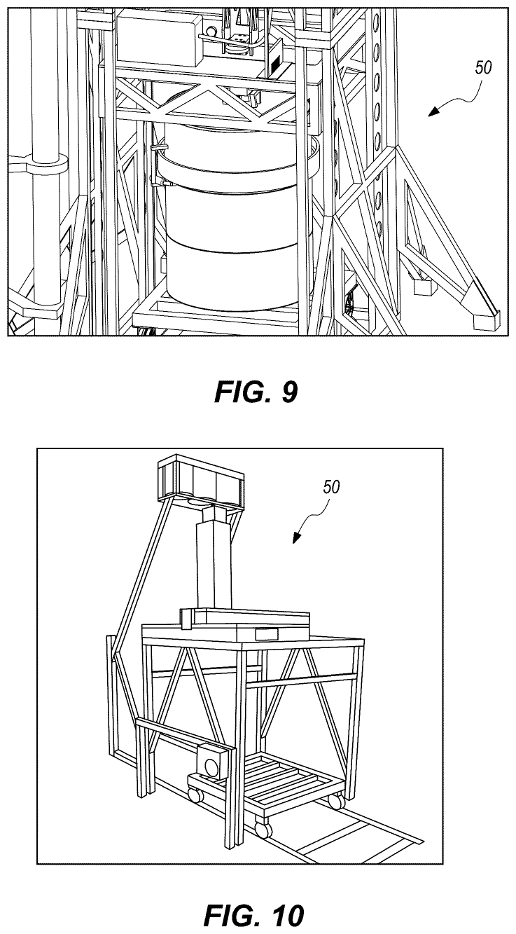

For very large part dimensions on the order of 1 m and above, we anticipate that the non-conformal welded AM-HIP manufacturing approach for using a HIP can 40A shown schematically in FIG. 7.1A to 7.1F will be more practical than the in-situ fabrication method of the HIP can 40B shown in FIG. 7.2A to 7.2E. FIGS. 8A, 8B, 9 and 10 show our large-scale AM-HIP manufacturing system 50 that consists of a high-speed multi-material printhead mounted on a Cartesian gantry. The Z-axis on this system is actuated via an elevator-type platform that has the XY gantry and an on-board TIG welding system. The build cartridge is on a rail assembly for ease of transport after the 3D printing process is complete. The modular HIP ring system allows the system to easily scale in Z-height for different part dimensions. As seen in FIG. 8A, the print begins on the lowest level, which is a cylindrical build cartridge with a single ring height. As the build progresses, additional rings with stepped edges, are inserted into the top of the previous ring so the printing process can continue, as seen in FIG. 8B. After the print is complete, an on-board TIG welding system connects each of the rings together, as seen in FIG. 9. As a final step, the powder level is raised to the top of the welded assembly and a cap/port fixture is welded to the top of the cylinder. FIG. 10 shows Grid Logic's GL-1000 large-scale 3D powder printer with a maximum build volume of 1 m³ (1000 mm×1000 mm×1000 mm).

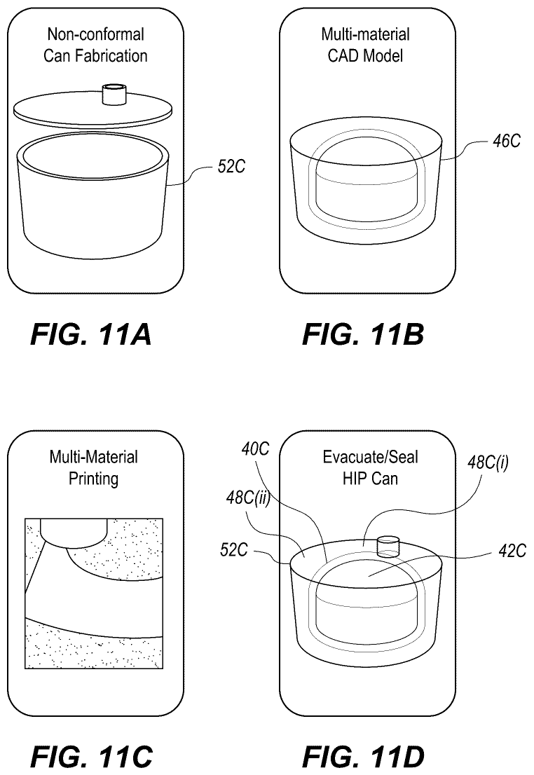

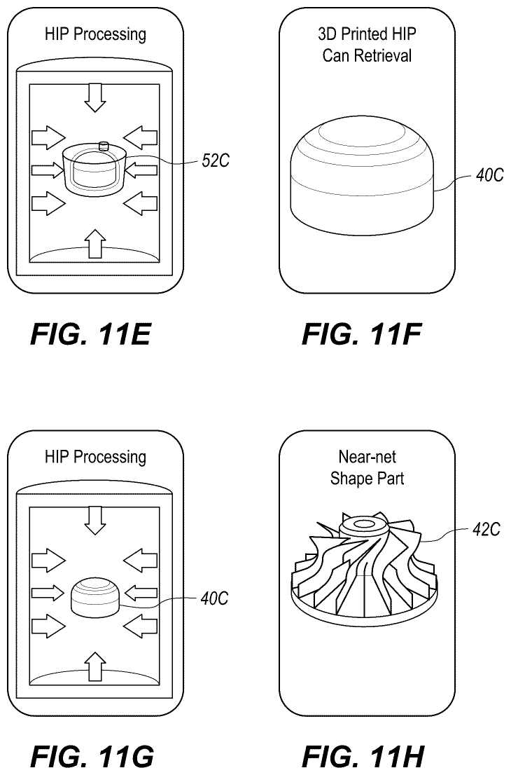

Refractory and other high-temperature materials can be formed into complex parts by multiple HIP processes. FIGS. 11A to 11H illustrate refractory part fabrication by 3D printing a refractory metal HIP can 40C around a part 42C, within a non-conformal cylindrical HIP can 52C. In this process, the part 42C, a first supporting powder 48C(i) for the part 42C, the refractory metal HIP can 40, and a second supporting powder for the HIP can 40 are printed using a multi-material powder printing process (FIGS. 11A to 11C) based on a CAD model 46C. After the print is complete, the non-conformal HIP can 52C is evacuated and sealed according to standard procedures in the field (FIG. 11D). The non-conformal HIP can 52C contains the second supporting powder 48C(ii) on the outside, a 3D powdered structure in the shape of the refractory metal HIP can 40C within and supported by the second supporting powder 48C(ii), the second supporting powder 48C(ii) onside the HIP can 40C, and a 3D powder structure for the part 42C that consists of materials that must be processed at very high temperatures.

After multi-material printing the powders in the HIP can 52C, the entire assembly including the non-conformal HIP can 52C is then HIP processed at a temperature that consolidates the 3D printed refractory metal HIP can 40C within the HIP can 52C, but not necessarily the part 42C that is within the 3D printed HIP can 40C (FIG. 11E). The successive layers that are printed within the non-conformal HIP can 52C are thus processed at a temperature and pressure that results in the formation of a dense HIP can 40C surrounding unconsolidated powder for the part 42C and that deforms the non-conformal can.

As an example, zirconium diboride is an ultra-high temperature ceramic material that can be consolidated in a HIP at temperatures above 1600° C. Standard steel or nickel-alloy HIP cannot be used at these temperatures. Molybdenum (Mo), tantalum (Ta), or other refractory metals, however, can be used. These materials are difficult to form into cans due to the high melting temperature of the materials and the poor mechanical properties at room temperature. In general, Mo is the material of choice for high-temperature HIP processing because of the relatively low cost and ease of welding.

For example, HIP processing at 1350° C. and 14,000 psi will consolidate the Mo powder, but not the zirconium diboride powder within the Mo can. After the initial processing at 1350° C., the sealed Mo can be removed from the second supporting powder 48C(ii) and HIP processed again at an elevated temperature (i.e., >1350° C.) to sinter/consolidate the refractory material inside the HIP can 40C (FIGS. 11F and 11G).

This process allows for the fabrication of conformal HIP cans using very high temperature materials in order to process extremely high temperature materials without having to fabricate and leak check expensive refractory metal cans.

Other materials may also be used to form the high-temperature HIP can 40C if they can be easily consolidated at temperatures attainable with standard steel or nickel-alloy cans. A number of high temperature glasses, for example, can be used to fabricate the internal HIP can 40C instead of the refractory metal powder. The part 42C is then removed from the HIP can 40C (FIG. 11H).

In general, cylindrical HIP cans are commonly used to consolidate metals and ceramic powders in a hot isostatic press. These cans are typically distorted in an irregular hourglass-like shape during the HIP process. Undulations in the side wall of the cylinder often occur due to non-isotropic mechanical properties of the HIP can 40 at elevated temperature and pressure, and variations in the powder pack density within the HIP can 40.

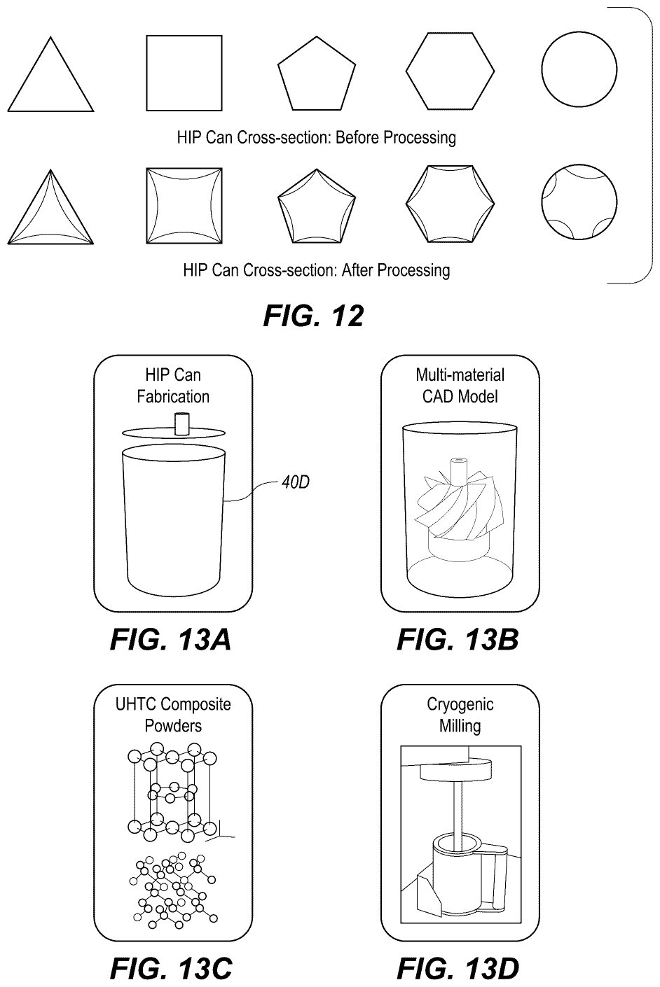

Alternative cross-sections of HIP cans are shown in FIG. 12. These shapes consist of simple polygons with an increasing number of flat sides of equal length, in top-down cross-sectional view. During the HIP process, the flat walls of these structures collapse in a more controlled manner as compared to the cylindrical HIP can on the right. In general, the pressure exerted on the part (located in the center of the HIP can) will increase uniformly as the number of sides increase. The hexagonal HIP can structure is expected to possess the largest volume of uniform pressure in the center of the HIP can with the minimum number of sides. The cylindrical can, however, does not possess a flat surface and will collapse with irregular undulations, as shown. These undulations may result in a non-isotropic pressure distribution in the supporting media and an associated variation in density of the HIP-processed part. There is a balance between the size of the part to be 3D printed, the overall shape of the part, and the complexity of the HIP can construction.

Multi-material printing of powders in a HIP can 40 allows for the possibility of synthesizing materials from precursor materials during the HIP process. Reaction-bonded Silicon Carbide (SiC) and gamma Titanium aluminide (TiAl) are two composite materials that can be formed in-situ during the HIP process.

Ultra-high temperature ceramics (UHTCs) have properties that make them an attractive choice for a variety of engineering applications. With melting temperatures in excess of 3000° C. (5432° F.), high thermal and electrical conductivities, and excellent oxidation resistance at high temperatures, these materials are ideally suited for use in extreme temperature applications.

Zirconium diboride (ZrB2) is a prime candidate material for extreme temperature applications because of its very high melting point, low density, relatively low resistivity, high thermal conductivity, and strength at high temperature. In addition, the materials properties of ZrB2 can be improved significantly with the addition of sintering aids such as molybdenum disilicide (MoSi2) and silicon carbide (SiC). ZrB2/SiC composites (T. G. Aguirre, et al., “Zirconium-diboride silicon-carbide composites: A review”, Ceramics International 28 (2022) 7344-7361; G. Zhang, et al., “Reactive Hot Pressing of ZrB2-SiC Composites”, J. Am. Ceram. Soc. 83 [9] 2330-2332 (2000); W. C. Tripp et al., “Effect of SiC Addition on the Oxidation of ZrB2”, A. Ceram. Soc. Bull. 52 [8] 612-16 (1973); R. Inoue, et al., “Oxidation of ZrB2 and its Composites: A Review” J Mater Sci (2018) 53: 14885-14906) for example, have been shown to possess dramatically improved oxidation resistance at high temperatures in air, making it an ideal candidate material for hypersonic applications if geometrically complex shapes can be reliably manufactured. (D. R. Tenney, et al., “Materials and Structures for Hypersonic Vehicles,” ICAS-88-2.3.1 (1988); M. M. Opeka, et al., “Oxidation-Based Materials Selection Form 2000° C.+Hypersonic Aerosurfaces: Theoretical Considerations and Historical Experience,” J. Mater. Sci., 39, 5887-904 (2004); L. Kaufman and H. Nesor, “Stability Characterization of Refractory Materials Under High Velocity Atmoshpheric Flight Conditions”; pp. 1-370 in Vol. Part III, Volume III, Experimental Results of High Velocity Hot Gas/Cold Wall Tests. AFML-TR-69-84 (DTIC AD 867307), ManLabs, Inc., Cambridge, Mass, 1970.; D. M. Van Wie, et al., “The hypersonic environment: required operating conditions and design challenges”, J. Mater. Sci. 2004; 39 (19):5915-24).

In general, UHTC parts and components are fabricated from ceramic powders using a combination of temperature and pressure to form the final part with minimal residual porosity. Hot Press (HP) (T. G. Aguirre, et al., “Zirconium-diboride silicon-carbide composites: A review,” Ceramics International 28 (2022) 7344-7361; W. G. Farenholtz, et al., “Refractory Diborides of Zirconium and Hafnium”, J. Am. Ceram. Soc., 90 [5] 1347-1364 (2007); R. Telle, et al., “Boride-Based Hard Materials”; pp. 802-945 in Handbook of Ceramic Hard Materials, Vol. 2, Edited by R. Riedel. Wiley-VCH, Weinheim, 2000) and Spark Plasma Sintering (SPS) (S. D. Oguntuyi, et al., “Spark Plasma Sintering of Ceramic Matrix Composite of ZrB2 and TiB2: Microstructure, Densification, and Mechanical Properties—A Review”, Metals and Materials International (2021) 27:2146-2159) technologies, for example, are capable of fabricating simple parts (e.g. discs, plates, rods, etc.) with near theoretical density. Unfortunately, the high melting temperatures and low fracture toughness of these materials at room temperature make the fabrication of geometrically complex parts difficult. The development of a low-cost, reliable manufacturing process capable of producing geometrically complex UHTC parts and components, however, would allow these materials to be used in a number of demanding applications including leading edge aerospace components, hypersonic thermal protection systems, and customized crucibles for metal casting.

AM, in principle, offers an alternative route to the fabrication of parts using UHTC materials. In conventional AM systems, a thin layer of powder is applied to the surface of a powder bed, and a localized energy source (e.g., laser or electron beam) is used to selectively melt material in a precise pattern. Both laser powder bed fusion (LPBF) and electron beam powder bed fusion (EBM) AM processes have successfully fabricated small sample coupons and parts using UHTC powders (T. G. Aguirre, et al., “Zirconium-diboride silicon-carbide composites: A review”, Ceramics International 28 (2022) 7344-7361; M. C. Leu et al., “Investigation of laser sintering for freeform fabrication of zirconium diboride parts”, Virtual and Physical Prototyping, 7:1, 25-36, DOI: 10.1080/17452759.2012.666119; M. C. Leu, et al., “FREEFORM FABRICATION OF ZIRCONIUM DIBORIDE PARTS USING SELECTIVE LASER SINTERING”, 2008 International Solid Freeform Fabrication Symposium, http://dx.doi.org/10.26153/tsw/14963) but often these coupons exhibit porosity and micro-cracks as a result of the very high temperatures required to melt the powder and the rapid cooling of the melt pool. Alternatively, binder jet AM technology has been used to fabricate complex ceramic parts. In this process, an organic binder is typically used to fabricate a mechanically fragile green part, which is then processed first at low temperature to remove the binder and then at high temperature to sinter the part 42 to high density. Complications arise in the process due to incomplete removal of the binder and deleterious reactions with the ceramic powder, which may result in increased porosity and reduced phase purity of the ceramic material. In order to overcome the current technology limitations of UHTC part fabrication using LPBF, EBM, and binder jet AM technologies, a new approach is needed.

Our AM process facilitates the fabrications of geometrically complex UHTC parts using a multi-material printing technology coupled with conventional HIP processing. This 3D printing technology allows for the selective deposition of UHTC powder and a supporting powder on layer-by-layer basis within a standard non-conformal HIP can to create a geometrically complex 3D powdered structure without the use of any binder. After the printing process, the HIP can is sealed and evacuated for subsequent processing in a hot isostatic press. The end-to-end manufacturing process includes the preparation of the UTHC powder, the multi-material 3D printing of UHTC and supporting ceramic powders, and the HIP processing of the as-printed 3D powder structure. The combination of multi-material 3D printing technology with conventional ceramic HIP processing technologies will result in a manufacturing process capable of producing complex ceramic and UHTC parts for extreme temperature applications.

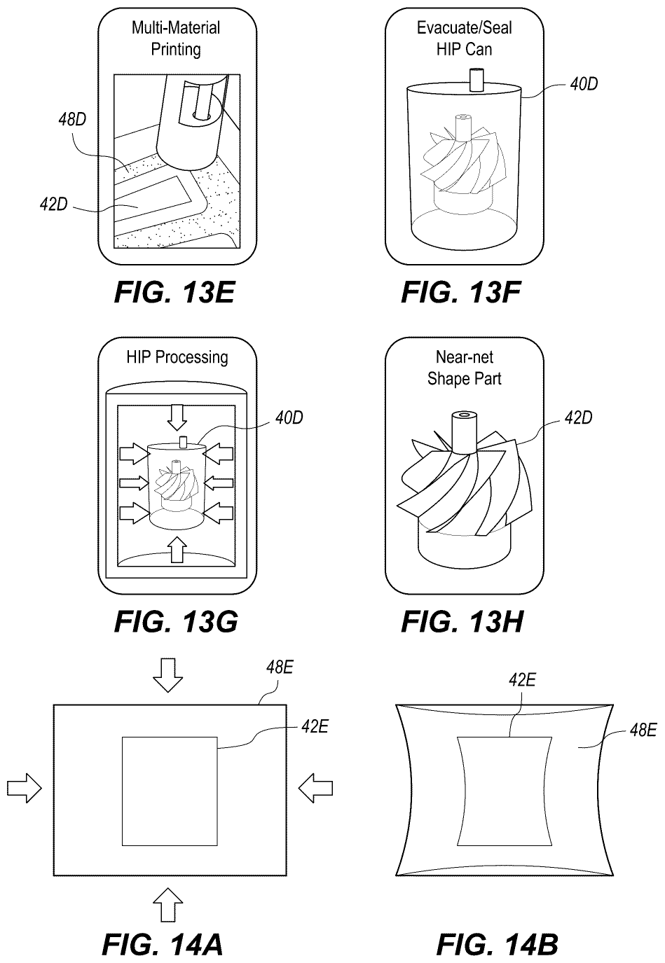

The UHTC manufacturing process is shown schematically in FIGS. 13A to 13H. The end-to-end process consists of six general steps.

FIGS. 13A and 13B: HIP can Fabrication. In FIG. 13A, a non-conformal welded HIP can 40D is fabricated using molybdenum (Mo) and Mo-alloy sheet as is used in high-temperature (e.g., >1500° C.) HIP processing. The HIP can 40D is cylindrical or rectangular in shape. In FIG. 13B, a multi-material CAD model 46D is designed using UHTC composite powders and a supporting powder 48D. The supporting powder 48D is used to maintain the shape of the ceramic powder during 3D printing and to transfer pressure to the part 42D during the HIP process.

FIGS. 13C and 13D: Cryogenic Milling of UHTC Materials. UHTC powders are combined with SiC powder and cryomilled in liquid argon in an inert atmosphere. This process will result in an intimate mixture of all constituents for use in our multi-material powder printing system.

FIG. 13E: Multi-Material Printing. The build is printed using our inert atmosphere multi-material printer with a 200 mm×200 mm×100 mm build volume. Grid Logic's 3D powder printers allow for the deposition of 3D powder structures in the HIP can 40D without the use of a carbon-containing binder. These binders are commonly used in binder jet AM and must be carefully removed during a de-binding heat treatment. Multi-material printing of 3D structures directly in a HIP can 40D without the use of binders obviates this problem.

FIG. 13F: Evacuate/Seal HIP Can. After the multi-material print, each non-conformal HIP can 40D are degassed and sealed via TIG welding under inert atmosphere. The sealed cans are helium leak checked before shipping to the HIP processing facility.

FIG. 13G: HIP Processing. See FIG. 7.1E above.

FIG. 13H: Near-net Shape UHTC Part. A NNS ZrB₂/SiC composite part 42D are recovered from the non-conformal welded HIP can 40D after processing. This includes the removal of the HIP can 40D and retrieving of the part 42D from the supporting powder 48D, the latter of which can be re-used.

As discussed above, geometry of the HIP can can impact the overall shape of the 3D printed part located within the HIP can. This is primarily a result of the properties of the supporting powder that surrounds the part. Unlike a true fluid, the movement of a particulate material under pressure is not isotropic, and thus the forces experienced by the part during the high temperature/high pressure HIP process is anisotropic and results in the distortion of the part during consolidation.

FIGS. 14A and 14B show a schematic of a 3D printed powder part 42E in a supporting powder 48E. The external cylindrical HIP can is not shown in this representation. During the HIP process, the HIP can is heated to an elevated temperature and isostatic pressure (shown by the arrows in FIG. 14A) is applied on the outside of the HIP can at a certain temperature. The temperature/pressure profile for the process depends on the particular material to be consolidated in the HIP can. As discussed previously, the isostatic pressure applied to the HIP can results in a differential force profile, which causes the surface of the HIP can to collapse. The hourglass shape in FIG. 14B is a typical deformation observed in the HIP canning process. This collapse is due to the densification of the powder part during the HIP and the anisotropic forces exerted on the HIP can that result from the geometry of the HIP can itself.

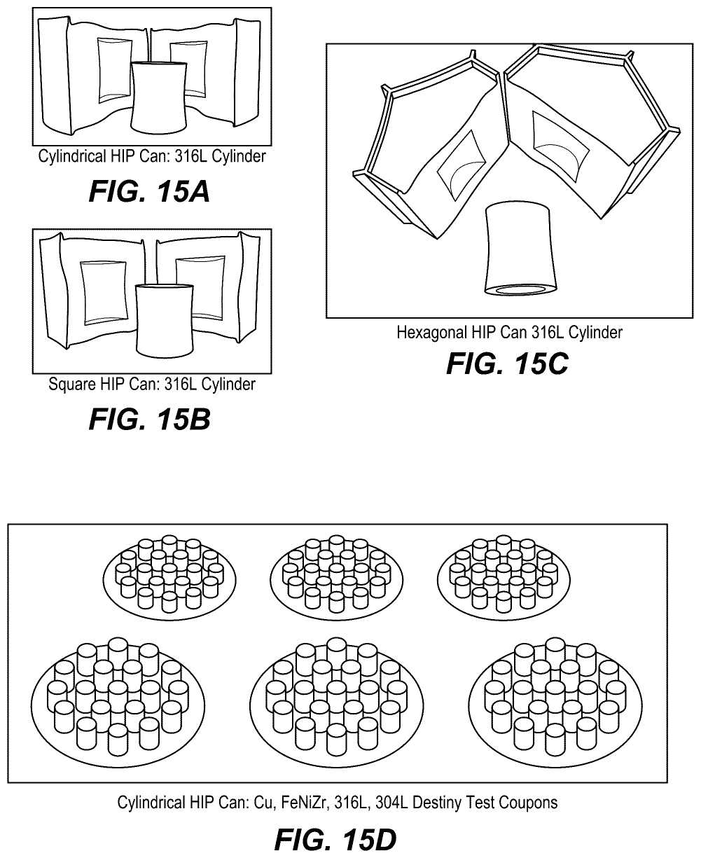

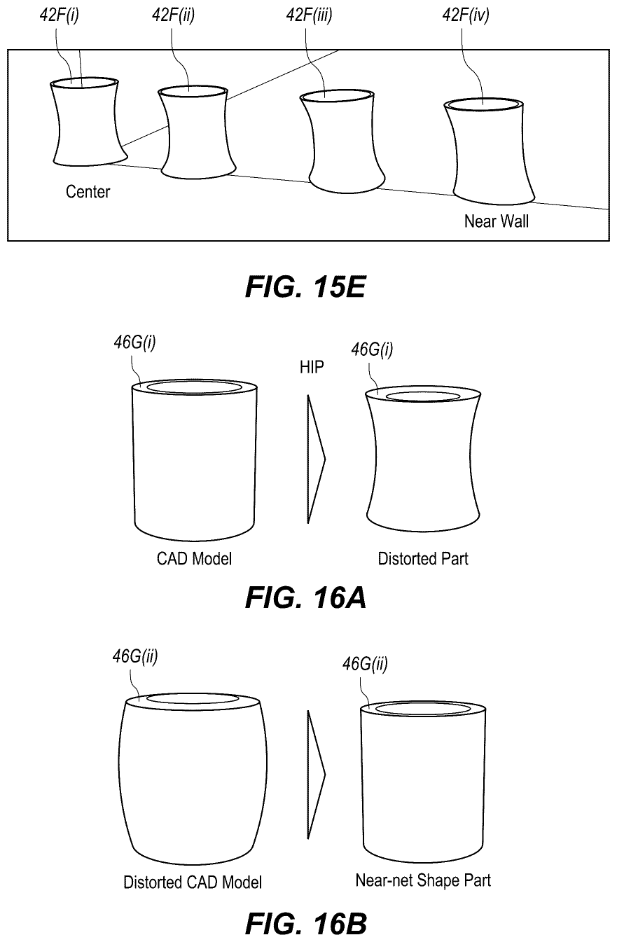

FIGS. 15A) to 15C shows the same cylindrical tube fabricated using different shaped HIP cans. In all cases the part has an hourglass shape due to the anisotropic forces exerted on the powder part during the HIP cycle. As shown in FIGS. 15D and 15E, in general, the extent of the distortion is a function of the print density of the powder part, the print density of the supporting powder, the distance from the HIP can wall to the powder part 42F(i) to 42F(iv), and, to some extent, the shape of the HIP can.

One approach to fabricating NNS parts using this multi-material AM HIP process is to develop and 3D print a distorted CAD model powder part such that during the HIP cycle, the distorted part deforms to the target NNS geometry. This is shown schematically in FIGS. 16A and 16B
Approach 1
   Modify CAD model of part to account for non-isotropic forces on HIP can
   Calculate required distortion using Finite Element Analysis
      Input
      CAD model 46G(i) of part
      Materials properties of metal powder
      HIP can shape
      Materials properties of HIP can and weld
      Materials properties of support powder

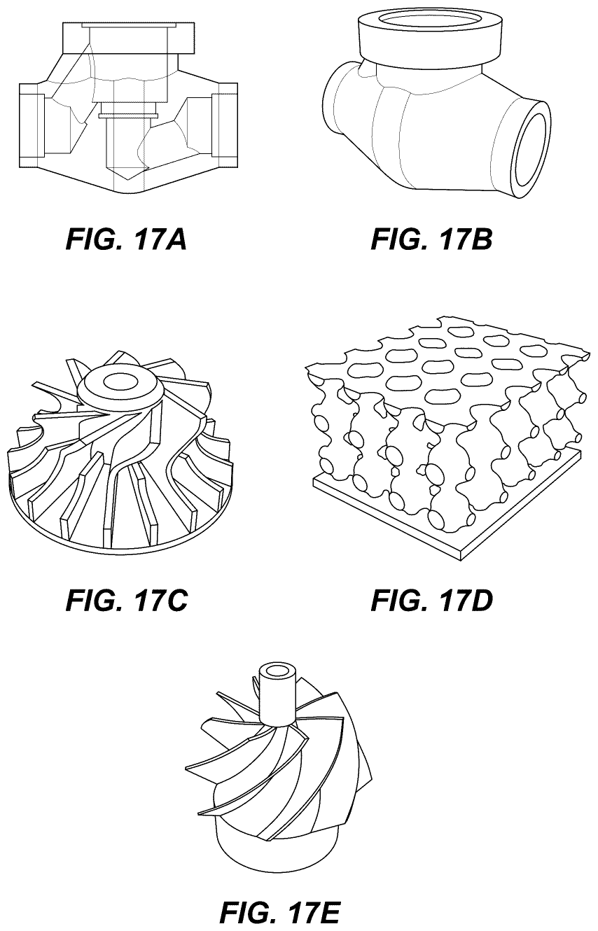

In this case, the distorted powder part 46G(ii) is printed in the supporting powder (similar to that of the distorted CAD model 46G(ii) shown in FIG. 16B) and upon processing in the HIP the distortion in the printed powder part results in the formation of the undistorted NNS part 42G(ii) instead of a distorted part 42G(i). Many parameters are needed to calculate the distortions in the original part to generate the NNS part during the HIP cycle. While it is possible to perform these calculations for simple parts, the problem quickly becomes intractable for complex geometries such as those shown in FIGS. 17A to 17E. This approach is thus much more difficult with geometrically complex parts.

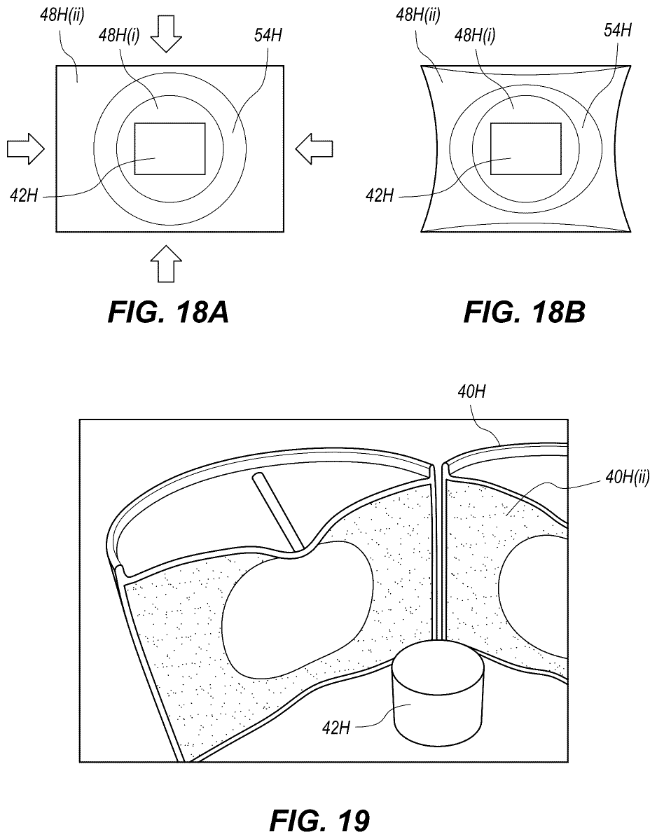

As an alternative, it is possible to 3D print another powder in the supporting powder that allows for a more isotropic pressure distribution on the original powder part. This is shown schematically of FIGS. 18A and 18B, which shows in side elevation a multi-material print that contains the powder part 42H, the supporting powder 48H(i) that surrounds the part 42H, a shell of glass 54H in powder form that surrounds the powder part 42H and the internal supporting powder 48H(i), and the supporting powder 48 that surrounds all of the other powders. A horizontal layer that is printed includes sequentially from the inside, a layer of the part 42H, a first supporting powder 48H(i) for the part 42H, the portion of glass 54H, and a second supporting powder 48H(ii) for the portion of glass 54H. Again, the HIP can is not shown in this schematic representation.

The difference in this case is that the glass powder, at elevated temperatures, forms a viscous liquid that acts as a force distribution substance. The viscous glass 54H then causes more uniform distribution of pressure/forces on the internal supporting powder 48H(i) and the powder for the part 42H and to reduce distortion of the part 42H. The placement of this viscous liquid boundary between the HIP can and the external supporting powder 48H(ii) and the internal supporting powder 48H(i) and the powder for the part 42H effectively on the other side reduces the anisotropy associated with the external geometry of the HIP can. In other words, the molten glass 54H at high temperatures creates a medium that results in an even pressure distribution on the internal supporting powder 48H(i) and/or the powder of the part 42H that then allows for the more uniform densification of the powder, thus creating an NNS part 42H.

FIG. 19 shows an example of a part that was fabricated using this process. The model consisted of a cylindrical part 42H surrounded by a spherical supporting powder 48H(i) (that has been removed) and a spherical shell of glass 54H (that has been removed) powder. The HIP process resulted in a significant distortion of the shell structure made out of the glass 54H, but the powder part geometry is essentially preserved. Again, at elevated temperatures, the glass 52 acts as a viscous liquid and the pressure on the internal powders is largely uniform. The HIP can 40 has deformed together with the supporting powder 48H(i).

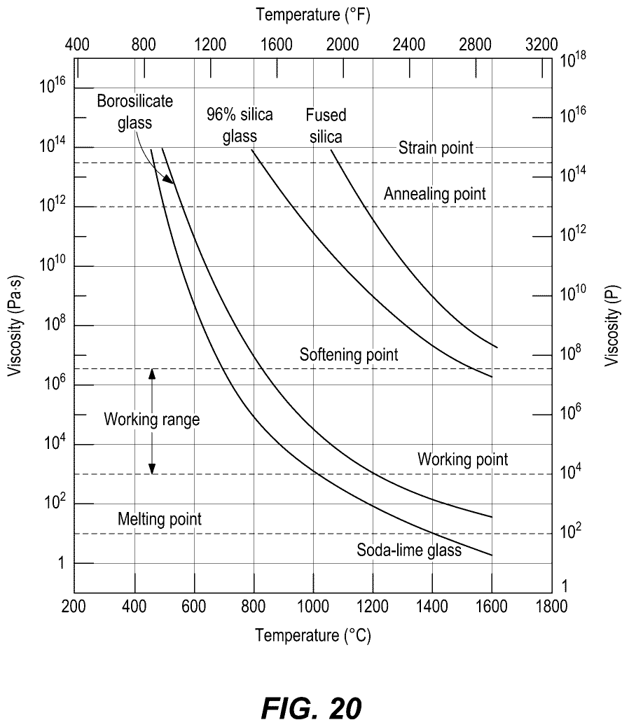

FIG. 20 shows the viscosity of some glasses as a function of temperature. In the AM/HIP process described here, it is important that the viscosity of the glass 54H shell remain high enough to maintain the shape of the internal 3D printed powders, but low enough to allow for little to no pressure differentials in the glass 54H volume. These temperatures exist approximately within the softening point and melting point of the specific glass 54H. In general, the softening point of a glass 54H is when the viscosity is less than approximately 10⁸ P (see the dashed line in the Figure). With this viscosity, the glass 54H can still be handled without a significant change in dimension, but can be worked carefully. At viscosities less than the softening point, but greater than the working point, the glass 54H is easily deformed, but remains highly viscous (e.g., glass 54H can be worked and blown at these viscosities). At higher temperatures near and above the melting point, the viscosity decreases to a point where the glass 54H behaves like a free flowing liquid.

In general, the temperatures used to form NNS parts using glass powder should occur at temperatures higher than the softening point and lower than the melting point of the glass 54H. Depending on the glass, there is a wide range of operational temperatures available in the AM/HIP process. Soda-lime glass, for example, has a potential working temperature range between 700° C. to 1400° C. Borosilicate glass, on the other hand, has a working range from about 800° C. to over 1600° C.

The invention described above incorporates glass 54H as a uniform pressure medium. The general requirement is that the materials (i.e., glass 54H in this case) have a temperature-dependent viscosity that allows for the even distribution of forces on the powder of the part at the temperatures/pressures used to consolidate the powder part material. In addition to a wide variety of glasses, candidate uniform pressure materials could include certain salts, mixtures of molten salts, and ceramic/salt mixtures. For example, the spherical shell structure made out of the glass 54H shown in FIGS. 18A and 18B and 19 could be a mixture of zircon and sodium chloride (NaCl). If, for example, the shell material is 80% by volume zircon sand and 20% by volume NaCl, then at temperatures above the melting point of NaCl (about 800° C.) the material will act like a thick paste and possess an effective viscosity that is within the working range described above. Essentially, the paste will uniformly distribute the forces in a similar way to the glass 54H. Other molten salts or mixtures of molten salts can also be used in this application. An advantage of using a salt in this process is that the sand/salt mixture can be immersed in water to dissolve the salt and release the part 42H.

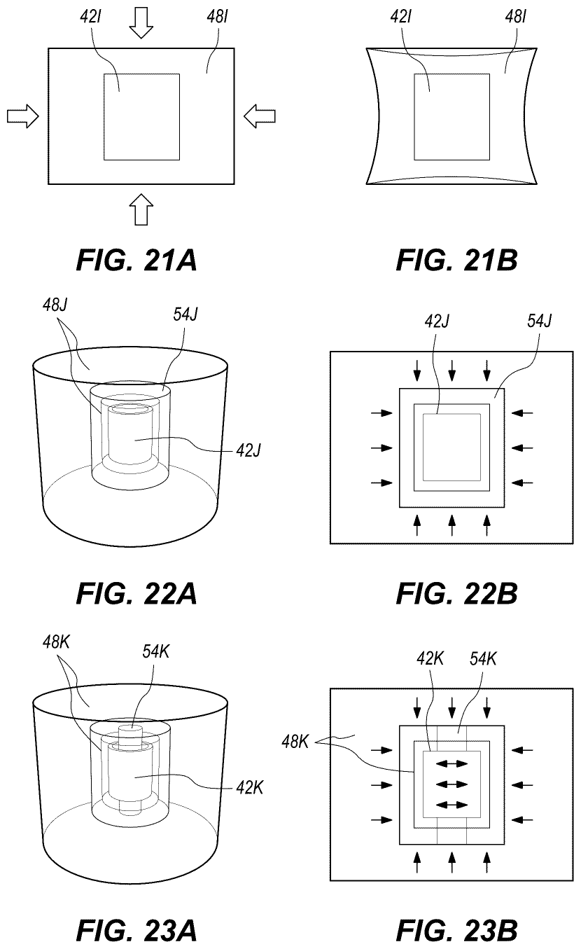

Alternatively, the entire supporting powder 48 (without an inner shell such as in FIG. 18B) could also consist of the sand/salt mixture as shown in FIGS. 21A and 21B wherein the supporting powder 48I includes a small amount of melted salt (fluid) added to the zircon powder or other primary powder. The composite mixture allows for the even redistribution of the forces on the internal powder of the part 42I.

The general approach is to place a material (e.g., glass, composite ceramic/salt, etc.) between the HIP can and the part 42H or 421 that behaves more like a viscous liquid than a particulate solid at the temperatures encountered during the HIP cycle. In this manner, the forces on the part 42H or 421 during the temperature/pressure induced sintering are more uniform and the part 42H or 421 geometry is much closer to the as-designed shape and less dependent on the shape of the HIP can. This can be accomplished with glass, mixtures of materials that have solid and minor liquid components (e.g., sand/glass, sand/molten salt, ceramic/glass, metal/glass, etc.) or certain metal alloys at temperatures within the so-called “mushy” zone above the solidus temperature and below the liquidus temperature.

The viscous structure around the part 42H or 421 does not necessarily need to be a spherical shell as shown in FIGS. 18A and 18B and 19. For a uniform distribution of forces on the part 42H or 421, the shell should surround the part 42H or 421 and be thick enough such that there is no pressure differential in the viscous layer that could significantly distort the shape of the part 42H or 421. FIGS. 22A and 22B show a simple cylindrical surround made out of the glass 54J around a tubular powder part 42J. During the HIP process, this surround is sufficiently thick to equalize the pressure around the part 42J when the powder of the glass 54J softens and achieves the necessary viscosity. In this example, the supporting powder 48J (e.g., zircon, alumina, etc.) surrounds the powder of the part and is located inside of the powder part tube. At this location, this material 48J acts like a mandrel around which the powder material of the part 42J is pressed. An inner dimension (ID) of the part 42J will closely match an outer dimension (OD) of mandrel formed out of the support material 48J.

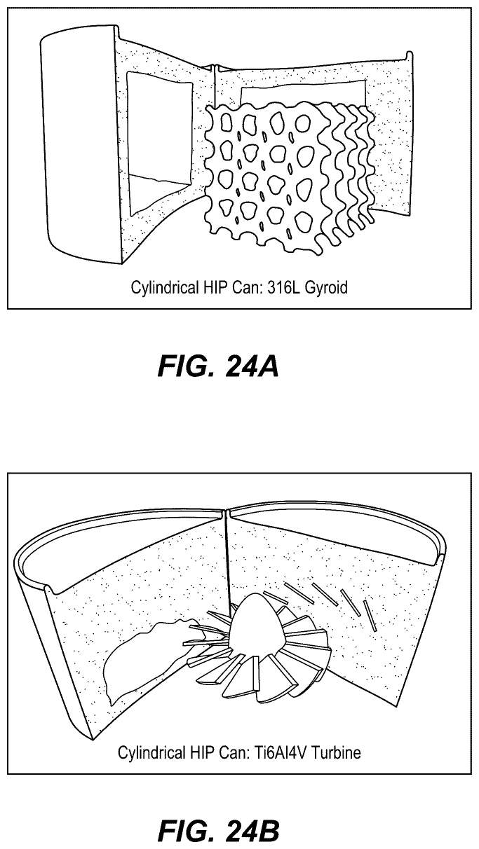

Alternatively, FIGS. 23A and 23B show the same tubular powder part 42K, but in this case the material of the glass 54K is also located within the center of the tube thus penetrating through the supporting powder 48K. In this case, the forces on the powder of the part 42K are applied from the outside of the tube and from the interior of the tube through the surrounding structure formed by the viscous glass 54K, which penetrates through the center of the cylinder formed by the powder for the part 42K. The final part 42K in this case will have an ID larger than the original CAD model and an OD smaller than the original CAD model due to the specific application of force enabled by the 3D printed geometry of the viscous structure in the HIP can. This AM/HIP process allows for the application of HIP induced forces specific to certain regions of the internal structure through the 3D placement of viscous structures within the HIP can. Although this invention has been described using relatively simple geometries, the application of this manufacturing process can be used to fabricate extremely complex structures such as those shown in FIGS. 17A to 17E and FIGS. 24A and 24B.

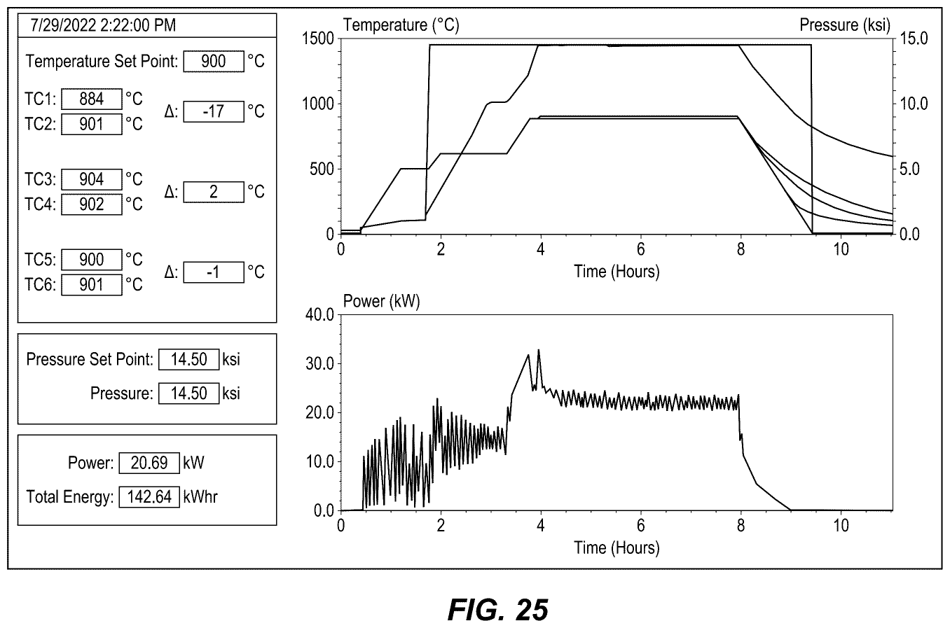

A typical HIP process cycle is shown in FIG. 25. The HIP can is first heated to about 500° C. under low pressure to soften the steel HIP can and anneal the welds. After some time, both the pressure and temperature are increased. In this example, the HIP can 40 was processed at 950° C./14,000 psi for 4 hours.

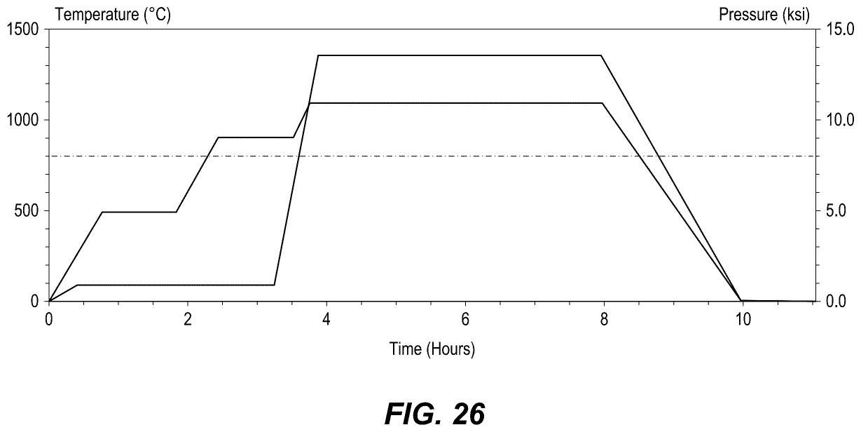

FIG. 26 shows a typical HIP process schedule for NNS part fabrication using a glass component surrounding the part. After loading the HIP can, the system is pressurized to a low pressure (e.g., 500 psi) and the HIP can is heated and soaked at about 500° C. to anneal the welds and soften the metal can. The temperature is then increased above the softening temperature of the glass, which serves to sinter/consolidate the glass powder into a partially-to fully-dense, viscous mass around the part. At this time, the pressure is increased in the system as the temperature is raised to the consolidation temperature for the part. With the increase in temperature and pressure, the HIP can distorts, which causes the now viscous glass component to distort as an entrapped liquid that imposes a uniform force distribution on the part. This results in the near uniform densification of the part. After a set time at high temperature/pressure, the temperature is lowered with the associated decrease in pressure. Variations in this general process are specific to the HIP can material, the powder part material, the glass powder, and the supporting powder.

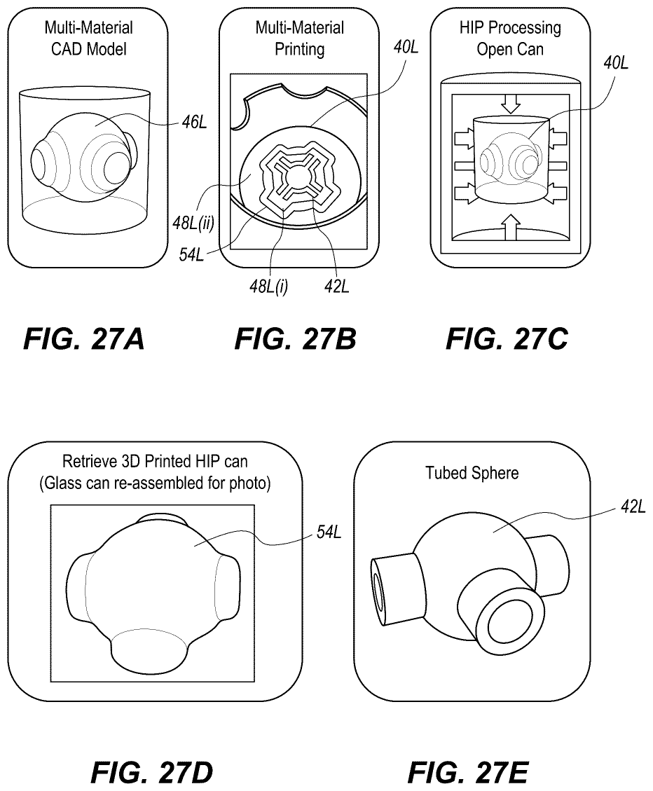

FIGS. 27A to 27E show the fabrication of a tubed sphere part 42L. A CAD model 46L (FIG. 27A) consists of three different materials: 316L metal alloy powder, zircon supporting powder, and a glass powder that is used to form a leak-free HIP canister around the part 42L.

The glass powder is selected from a number of possible glass combinations as shown in FIG. 20. The compositional details of the glass powder are tailored to the HIP process parameters (e.g., temperature and pressure) and the specifics of the powder material to be consolidated.

A conformal shell made out of glass 54L is printed (FIG. 27B) around the part 42L shown in the center of the 3D model 46 (FIG. 27A). After printing, the 3D powdered structure including the HIP can 40L, glass 54L, supporting powders 48L(i) and 48L(ii) and powder for the part 42L is processed using a HIP cycle that first fuses the glass 54L into a leak-free shell made out of glass 54L before applying pressure to consolidate the 316L powder (FIG. 27C). Unlike the AM-HIP process illustrated in FIGS. 7.1A to 7.1F, this consolidation process of the shell out of the glass 54L is carried out in an open HIP can 40L. After the HIP process, the HIP can made out of the glass 54L is retrieved (FIG. 27D) from the loose sand forming the supporting material 48L(ii), broken open, and the tubed sphere part 42L is removed from the loosely sintered zircon powder forming the supporting material 48L(i) inside of the shell formed by the glass 54L (FIG. 27E).

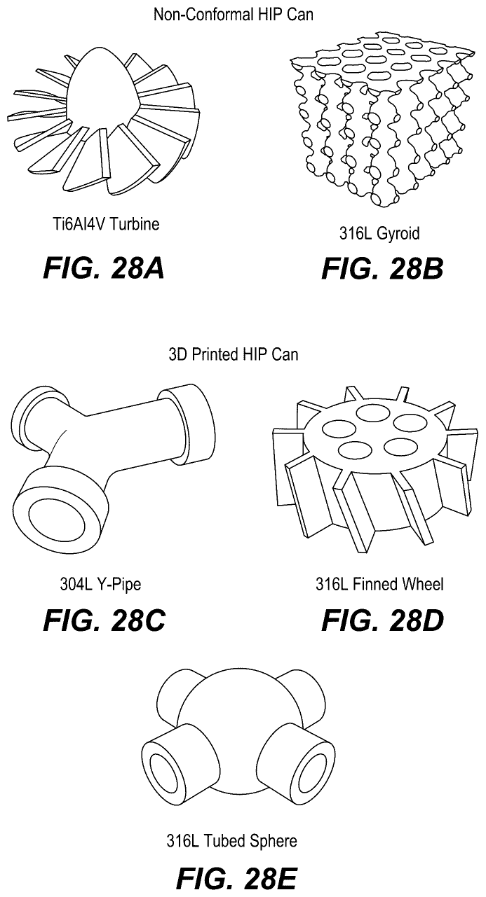

Using the AM-HIP processes illustrated in FIGS. 27A to 27E, a number of geometrically complex parts have been fabricated; examples of which are shown in FIGS. 28A to 28E. These examples consist of parts with thin walls, concave/convex structures, and internal voids designed to test the limits of the AM-HIP process.

Table 1 shows the density of select materials processed using the AM-HIP technology as measured by helium pycnometry. AM-HIP processed 304L, 316L, and Inconel 625 have high densities, but retain a degree of residual porosity at the temperatures. Tungsten has the highest porosity (i.e., lowest density) with the HIP processing parameters used to date.

TABLE 1
Density measurements of materials processed by AM-HIP.

| | | | Target | Measured | % |
|---|---|---|---|---|---|
| | Temperature | Pressure | Density | Density | of True |
| Material | (° C.) | (ksi) | (g/cm3) | (g/cm3) | Density |
| 304L | 950 | 14.5 | 7.9 | 7.69 ± 0.04 | 97.3 |
| 316L | 950 | 14.5 | 8.0 | 7.78 ± 0.05 | 97.3 |
| Inconel 625 | 1000 | 14.0 | 8.44 | 8.01 ± 0.14 | 94.9 |
| Ti6Al4V | 1200 | 14.0 | 4.43 | | |
| Tungsten | 1200 | 14.0 | 19.28 | 16.19 ± 0.09 | 84.0 |

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A method of forming a part, comprising:
printing successive layers, wherein each layer comprises at least a layer of the part and wherein the layer of the part is surrounded by a piece of a hot-isostatic press (HIP) can.

2. The method of claim 1, wherein:
the HIP can is a sealed container with the part inside the HIP can so that the HIP can is insertable in a HIP to increase a pressure on the outside of the HIP can to deform the HIP can.

3. The method of claim 1, further comprising:
locating the HIP can with the part inside the HIP can in a HIP;
increasing a temperature within the HIP can and a pressure on the outside of the HIP can using the HIP to deform the HIP can;
removing the HIP can with the part inside the HIP can from the HIP; and
removing the part from the HIP can.

4. The method of claim 3, wherein pressure deforms the part.

5. The method of claim 1, further comprising:
fabricating the HIP can;
developing a multi-material computer-aided design (CAD) model, wherein the successive layers are multi-material layers that are printed inside the HIP can based on the CAD model in the HIP can after the HIP can has been fabricated;
evacuating the HIP can after the layers have been printed inside the HIP can; and
sealing the HIP can after the HIP can has been evacuated.

6. The method of claim 5, wherein the multi-material layers are printed from a powder for forming the part and a supporting powder for supporting the powder for forming the part.

7. The method of claim 6, wherein the supporting powder transfers pressure to the powder for the part when increasing a temperature within the HIP can and a pressure on the outside of the HIP can using the HIP to deform the HIP can.

8. The method of claim 1, further comprising:
developing a multi-material computer-aided design (CAD) model, wherein the successive layers are multi-material layers that are printed based on the CAD model and each one of the successive layers that are printed includes the respective piece of the HIP can.

9. The method of claim 8, further comprising:
processing a build that results from the printing of the successive layers in an inert atmosphere at a select temperature that results in the formation of a dense HIP can surrounding unconsolidated powder for the part.

10. The method of claim 9, wherein the temperature consolidates the HIP can without sintering the powder for the part within the HIP can.

11. The method of claim 10, wherein the temperature consolidates the HIP can through at least one of sintering and metal infiltration.

12. The method of claim 8, wherein each layer includes a first supporting powder for powder for the part and a second supporting powder for powder for the HIP can.

13. The method of claim 8, wherein the successive layers that are printed within a non-conformal can and the non-conformal can is processed a temperature and pressure that results in the formation of a dense HIP can surrounding unconsolidated powder for the part and that deforms the non-conformal can.

14. The method of claim 1, wherein the HIP can is non-cylindrical in top-down cross-sectional view.

15. The method of claim 14, wherein the HIP can has a polygonal shape.

16. The method of claim 14, wherein the sides of the polygonal shape have equal length.

17. The method of claim 15, wherein the HIP can has at least three relatively flat sides.

18. The method of claim 17, wherein the HIP can has at least five relatively flat sides.

19. The method of claim 1, wherein the part is made of an ultra-high temperature ceramic powder.

20. The method of claim 1, wherein each layer includes a portion of a force distribution substance between the layer of the part and the piece of a HIP can, wherein the force distribution substance, at elevated temperatures, allows for more uniform distribution of forces to reduce distortion of the part.

21. The method of claim 20, wherein the force distribution substance is glass.

22. The method of claim 21, wherein each printed layer includes sequentially the layer of the part, a first supporting powder for the part, the portion of glass, and a second supporting powder for the portion of glass.

23. The method of claim 22, wherein the glass, at elevated temperatures, acts as a viscous liquid, which allows for more uniform distribution of forces on the first supporting to reduce distortion of the part.

24. The method of claim 21, wherein the glass has a working temperature of between 700° C. and 1600° C.

25. The method of claim 20, wherein the printed layers are printed from a powder for forming the part and a supporting powder for supporting the powder for forming the part, wherein the supporting powder includes a primary powder and melted salt added to the primary powder and a composite mixture allows for the even redistribution of the forces on the powder for the part.

26. The method of claim 21, wherein the glass, at elevated temperatures, is fused, further comprising:
removing the fused glass with the part inside the fused glass from the HIP can; and
breaking the fused glass open to remove the part from the fused glass.

27. The method of claim 26, wherein the HIP can is open when the glass is fused.

28-77. (canceled)
